(19) United States
(12) Patent Application Publication
(10) Pub. No.: US 2021/0327160 A1
(43) Pub. Date: Oct. 21, 2021

(54) AUTHORING DEVICE, AUTHORING METHOD, AND STORAGE MEDIUM STORING AUTHORING PROGRAM

(71) Applicant: Mitsubishi Electric Corporation, Tokyo (JP)

(72) Inventor: Takeru SHIRAGA, Tokyo (JP)

(73) Assignee: Mitsubishi Electric Corporation, Tokyo (JP)

(21) Appl. No.: 17/360,900

(22) Filed: Jun. 28, 2021

Related U.S. Application Data
(63) Continuation of application No. PCT/JP2019/000687, filed on Jan. 11, 2019.

(51) Int. Cl. G06T 19/20; G06T 7/73

(52) U.S. Cl. CPC G06T 19/20; G06T 2200/24; G06T 2219/2016; G06T 7/75

(57) ABSTRACT

An authoring device includes a user interface to receive an operation for designating a target object existing in real space; and processing circuitry to determine a reference point of a designation target, as the target object designated by using the user interface, on a reference plane related to the target object; to determine a first arrangement plane, arranged at a position including the reference point and on which a virtual object can be arranged, based on the reference plane and the reference point; and to determine one or more second arrangement planes obtained by rotating the first arrangement plane and on which the virtual object can be arranged, wherein the authoring device outputs information associating the first arrangement plane and the virtual object with each other and information associating the second arrangement planes and the virtual object with each other as authoring data.

### CROSS-REFERENCE TO RELATED APPLICATION

This application is a continuation application of International Application No. PCT/JP2019/000687 having an international filing date of Jan. 11, 2019.

### BACKGROUND OF THE INVENTION

### 1. Field of the Invention

The present invention relates to an authoring device, an authoring method and an authoring program.

### 2. Description of the Related Art

In recent years, a technology for presenting a user with an augmented reality (AR) image obtained by superimposing virtual information on an image of the real world is attracting great attention. For example, there has been known a technology of displaying a virtual object, as a virtual information part related to a designated target object, in the vicinity of the designated target object when the user has performed an operation of designating the target object as an object in the real world.

Patent Reference 1 proposes a device that obtains a reference surface (e.g., palm) as a surface of an object (e.g., hand) existing in the real space by analyzing information regarding the real space acquired by a camera and changes a virtual object displayed on an image display unit based on the reference surface.

Patent Reference 1: Japanese Patent Application Publication No. 2018-84886 (paragraphs 0087 to 0102, FIG. 8 to FIG. 11, for example)

However, the aforementioned conventional device has a problem in that there are cases where the visibility of the virtual object drops since the shape and the inclination of a plane on which the virtual object is arranged change depending on the shape and the inclination of the object existing in the real space.

### SUMMARY OF THE INVENTION

An object of the present invention, which has been made to resolve the above-described problem, is to provide an authoring device, an authoring method and an authoring program that make it possible to display an augmented reality image so as not to deteriorate the visibility of a virtual object.

An authoring device according to an aspect of the present invention includes a user interface to receive an operation for designating a target object existing in real space; and processing circuitry to determine a reference point of a designation target, as the target object designated by using the user interface, on a reference plane related to the target object; to determine a first arrangement plane, arranged at a position including the reference point and on which a virtual object can be arranged, based on the reference plane and the reference point; and to determine one or more second arrangement planes obtained by rotating the first arrangement plane and on which the virtual object can be arranged, wherein the authoring device outputs information associating the first arrangement plane and the virtual object with each other and information associating the second arrangement planes and the virtual object with each other as authoring data.

An authoring method according to another aspect of the present invention includes receiving an operation for designating a target object existing in real space; determining a reference point of a designation target as the designated target object on a reference plane related to the target object; determining a first arrangement plane, arranged at a position including the reference point and on which a virtual object can be arranged, based on the reference plane and the reference point; determining one or more second arrangement planes obtained by rotating the first arrangement plane and on which the virtual object can be arranged; and outputting information associating the first arrangement plane and the virtual object with each other and information associating the second arrangement planes and the virtual object with each other as authoring data.

According to the present invention, it becomes possible to display an augmented reality image so as not to deteriorate the visibility of the virtual object.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a diagram showing an example of a hardware configuration of an authoring device according to a first embodiment of the present invention;

FIG. 2 is a functional block diagram schematically showing a configuration of the authoring device according to the first embodiment;

FIGS. 3A to 3D are diagrams showing data handled by a data acquisition unit of the authoring device according to the first embodiment and parameters indicating positions and postures of cameras capturing images of the real space;

FIG. 4 is a diagram showing an example of target objects existing in the real space and object IDs assigned to the target objects;

FIG. 5 is a diagram showing an example of a planar virtual object;

FIG. 6 is a diagram showing an example of a solid virtual object;

FIG. 7 is a diagram showing a first designation method of designating a designation target by a user operation of surrounding a region on a target object as the designation target by straight lines;

FIG. 8 is a diagram showing a second designation method of designating a designation target by a user operation of designating a point on the target object as the designation target;

FIG. 9A is a diagram showing an example of a designation target region and a reference point designated by a user operation, FIG. 9B is a diagram showing an example of the reference point and a reference plane, and FIG. 9C is a diagram showing an example of a horizontal plane;

FIGS. 10A, 10B and 10C are diagrams showing a process of deriving an arrangement plane from the reference plane and the horizontal plane;

FIGS. 11A and 11B are diagrams showing a first deriving method and a second deriving method for deriving the arrangement plane, on which the virtual object is arranged, from the reference point and the reference plane;

FIG. 12A is a diagram indicating that virtual objects displayed on the arrangement plane can be seen when the designation target region is viewed from the front, and FIG. 12B is a diagram indicating that the virtual objects displayed on the arrangement plane cannot be seen when the designation target region is viewed from above;

FIG. 13 is a diagram showing an example of displaying the virtual objects by using billboard rendering in the state of FIG. 12B;

FIG. 14 is a diagram showing an arrangement plane derived by a multiple viewpoints calculation unit;

FIG. 15 is a diagram showing an arrangement plane derived by the multiple viewpoints calculation unit;

FIG. 16 is a diagram showing an arrangement plane derived by the multiple viewpoints calculation unit;

FIG. 17 is a flowchart showing the operation of the authoring device according to the first embodiment;

FIG. 18 is a diagram showing an example of a hardware configuration of an authoring device according to a second embodiment of the present invention;

FIG. 19 is a functional block diagram schematically showing a configuration of the authoring device according to the second embodiment; and

FIG. 20 is a flowchart showing an operation of the authoring device according to the second embodiment.

### MODE FOR CARRYING OUT THE INVENTION

Authoring devices, authoring methods and authoring programs according to embodiments of the present invention will be described below with reference to the drawings. The following embodiments are just examples and a variety of modifications are possible within the scope of the present invention.

### (1) First Embodiment

### (1-1) Configuration

### (1-1-1) Hardware Configuration

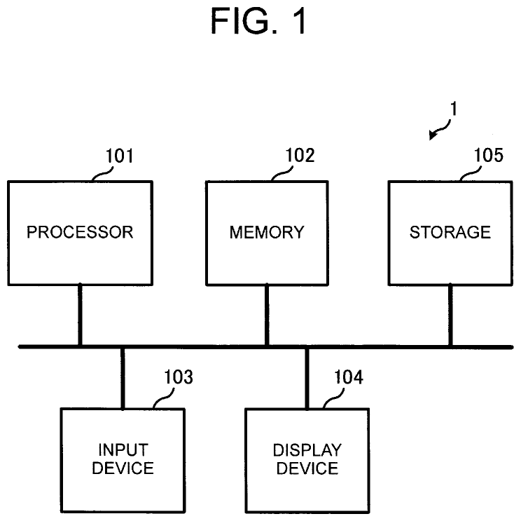

FIG. 1 is a diagram showing an example of a hardware configuration of an authoring device 1 according to a first embodiment. FIG. 1 does not show a configuration for executing rendering as a process of displaying an AR image based on authoring data including a virtual object. However, the authoring device 1 may include a configuration for acquiring information on real space such as a camera or a sensor.

The authoring device 1 may be implemented by processing circuitry. As shown in FIG. 1, the processing circuitry includes, for example, a memory 102 as a storage device storing a program as software, namely, an authoring program according to the first embodiment, and a processor 101 as an arithmetic processing unit that executes the program stored in the memory 102. The storage device may be a non-transitory computer-readable storage medium storing a program such as the authoring program. The processor 101 is an information processing circuit such as a CPU (Central Processing Unit). The memory 102 is a volatile storage device such as a RAM (Random Access Memory), for example. The authoring device 1 is a computer, for example. The authoring program according to the first embodiment is stored in the memory 102 from a record medium storing information via a medium information reading device (not shown), or via a communication interface (not shown) connectable to the Internet.

Further, the authoring device 1 includes an input device 103 as a user operation unit such as a mouse, a keyboard or a touch panel. The input device 103 is a user operation device that receives user operations. The input device 103 includes an HMD (Head Mounted Display) that receives an input made by a gesture operation, a device that receives an input made by a sight line operation, or the like. The HMD for receiving an input made by a gesture operation includes a small-sized camera, captures images of a part of the user's body, and recognizes a gesture operation that is the movement of the body, as an input operation to the HMD.

Furthermore, the authoring device 1 includes a display device 104 that displays images. The display device 104 is a display that presents the user with information when the authoring is executed. The display device 104 displays an application. The display device 104 can also be a see-through display of the HMD.

The authoring device 1 may also include a storage 105 as a storage device storing various types of information. The storage 105 is a storage device such as an HDD (Hard Disk Drive) or an SSD (Solid State Drive). The storage 105 also stores programs, data to be used at the time of executing the authoring, data generated by the authoring, and so forth. The storage 105 can also be a storage device outside the authoring device 1. The storage 105 can also be, for example, a storage device existing in the cloud and connectable via a communication interface (not shown).

The authoring device 1 can be implemented by the processor 101 executing a program stored in the memory 102. It is also possible to implement a part of the authoring device 1 by the processor 101 executing a program stored in the memory 102.

### (1-1-2) Authoring Device 1

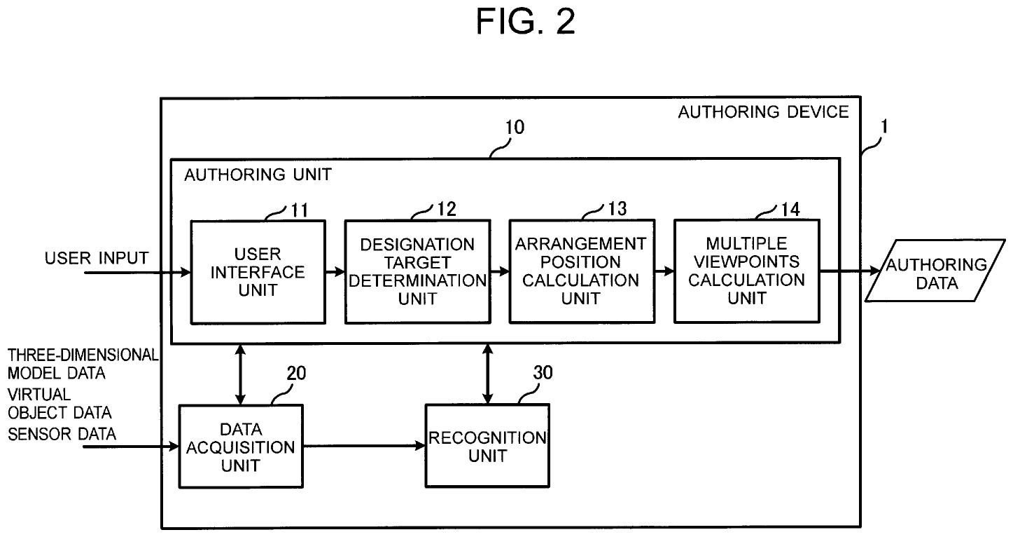

FIG. 2 is a functional block diagram schematically showing a configuration of the authoring device 1 according to the first embodiment. The authoring device 1 is a device capable of executing an authoring method according to the first embodiment. The authoring device 1 executes authoring in consideration of the depth of the virtual object.

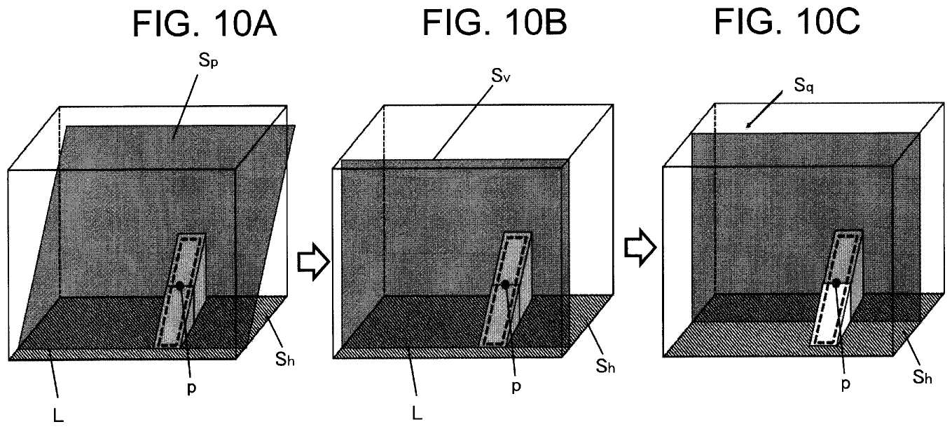

The authoring device 1
(1) receives a user operation for designating a target object existing in the real space,
(2) determines a reference point of a designation target as the designated target object on a reference plane related to the target object (this process is shown in FIGS. 9A to 9C which will be explained later),
(3) determines a first arrangement plane, which is arranged at a position including the reference point and on which the virtual object can be arranged, based on the reference plane and the reference point (this process is shown in FIGS. 10A to 10C which will be explained later),
(4) determines one or more second arrangement planes which are obtained by rotating the first arrangement plane and on which the virtual object can be arranged (this process is shown in FIGS. 14 to 16 which will be explained later), and
(5) outputs information that associates the first arrangement plane and the virtual object with each other and information that associates the second arrangement plane(s) and the virtual object with each other as authoring data to the storage 105, for example.

As shown in FIG. 2, the authoring device 1 includes an authoring unit 10, a data acquisition unit 20 and a recognition unit 30. The authoring unit 10 executes the authoring in response to a user operation as an input operation performed by the user. The data acquisition unit 20 acquires data to be used at the time of executing the authoring from the storage 105 (shown in FIG. 1). The recognition unit 30 executes processing such as image recognition that becomes necessary in the process of the authoring executed by the authoring unit 10. While the storage 105 in the first embodiment is shown in FIG. 1, the whole or part of the storage 105 can also be a storage device outside the authoring device 1.

### (1-1-3) Data Acquisition Unit 20

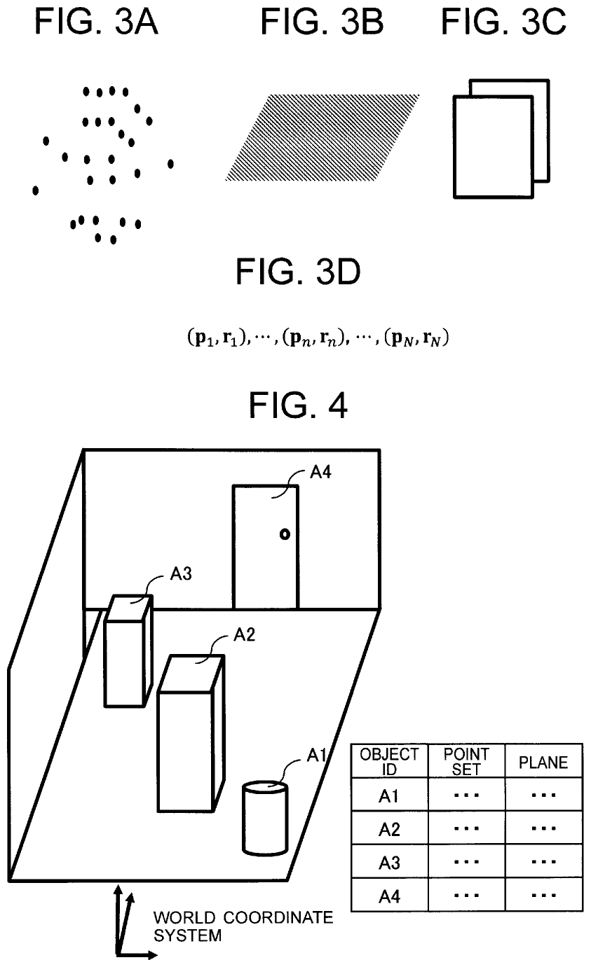

FIGS. 3A to 3D are diagrams showing data handled by the data acquisition unit 20 of the authoring device 1 according to the first embodiment and parameters indicating positions and postures of cameras capturing images of the real space. The cameras will be explained in a second embodiment. The data acquisition unit 20 acquires data to be used by the authoring unit 10 at the time of executing the authoring. The data to be used at the time of executing the authoring can include three-dimensional model data representing a three-dimensional model, virtual object data representing the virtual object, and sensor data outputted from the sensor. These items of data may also be previously stored in the storage 105.

### (Three-Dimensional Model Data)

The three-dimensional model data is data that three-dimensionally represents information regarding the real space in which the AR image is displayed. The three-dimensional model data can include the data shown in FIGS. 3A to 3C. The three-dimensional model data can be obtained by using the SLAM (Simultaneous Localization and Mapping) technology, for example. In the SLAM technology, the three-dimensional model data is obtained by capturing images of the real space by using a camera capable of obtaining a color image (i.e., RGB image) and a depth image (i.e., Depth image) of the real space (hereinafter referred to also as an “RGBD camera”).

FIG. 3A shows an example of a three-dimensional point set. The three-dimensional point set represents target objects as objects existing in the real space. The target objects existing in the real space can include, for example, a floor, a wall, a door, a ceiling, an article placed on the floor, an article hung down from the ceiling, an article attached to the wall, and so forth.

FIG. 3B shows an example of a plane obtained in a process of generating the three-dimensional model data. This plane is obtained from the three-dimensional point set shown in FIG. 3A.

FIG. 3C shows an example of images obtained by image capturing from a plurality of viewpoints and image capturing at a plurality of angles. In the SLAM technology, the three-dimensional model data is generated by capturing images of the real space from a plurality of viewpoints and at a plurality of angles by using RGBD cameras or the like. The images shown in FIG. 3C (i.e., image data) obtained at the time of the image capturing are stored in the storage 105 together with the three-dimensional point set shown in FIG. 3A, the plane shown in FIG. 3B, or both of the three-dimensional point set and the plane.

The information shown in FIG. 3D is information indicating the position and the posture of the camera in regard to each image. Assuming that k=1, 2, . . . , N (N: positive integer), pₖ represents the position of the k-th camera and rₖ represents the posture of the k-th camera, that is, an image capture direction of the camera.

FIG. 4 is a diagram showing an example of target objects existing in the real space and object IDs (identifications) assigned to the target objects. In FIG. 4, “A1”, “A2”, “A3” and “A4” are described as examples of the object ID. The three-dimensional model data is used in a process of determining a three-dimensional arrangement position of the virtual object, a process of deriving the position, the posture, or both of the position and the posture of a target object in an image, and so forth. The three-dimensional model data is one of multiple items of input data to the authoring unit 10.

The three-dimensional model data can include information other than the information shown in FIGS. 3A to 3D. The three-dimensional model data can include data of each target object existing in the real space. For example, as shown in FIG. 4, the three-dimensional model data can include the object ID assigned to each target object and partial three-dimensional model data of each target object to which an object ID has been assigned.

In the case shown in FIG. 4, the partial three-dimensional model data of each target object can be obtained by using the semantic segmentation technology, for example. For example, the partial three-dimensional model data of each target object can be obtained by segmenting data of the three-dimensional point set shown in FIG. 3A, data of the plane shown in FIG. 3B, or both of these sets of data into regions respectively belonging to the target objects. Further, Non-patent Reference 1 describes a technology of detecting regions of target objects included in point set data based on the point set data.

Non-patent Reference 1: Florian Walch, “Deep Learning for Image-Based Localization”, Department of Informatics, Technical University of Munich (TUM), Oct. 15, 2016.

### (Virtual Object Data)

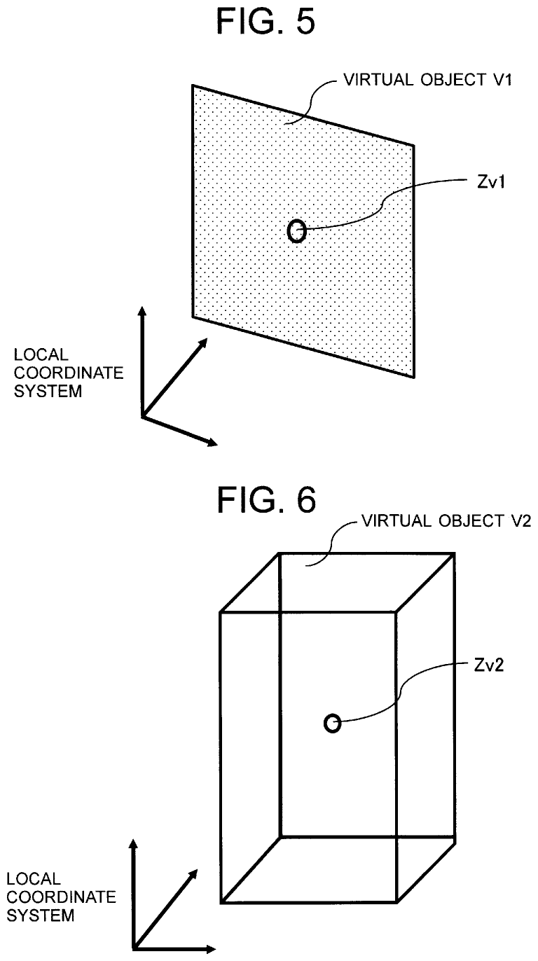

FIG. 5 is a diagram showing an example of a planar virtual object. FIG. 6 is a diagram showing an example of a solid virtual object. The virtual object data is data storing information representing a virtual object to be displayed as an AR image. The virtual objects handled here have two types of attributes.

A virtual object V1 shown in FIG. 5 is represented by a plane. The virtual object V1 corresponds to an image, motion video or the like. A barycenter position of the virtual object V1 is represented as Zv1. The barycenter position Zv1 has been stored in the storage 105 as coordinates in a local coordinate system.

A virtual object V2 shown in FIG. 6 is represented by a solid object. The virtual object V2 corresponds to data generated by a three-dimensional modeling tool or the like. The barycenter position of the virtual object V2 is represented as Zv2. The barycenter position Zv2 has been stored in the storage 105 as coordinates in a local coordinate system.

### (Sensor Data)

The sensor data is data to be used for assisting a process of estimating the position and the posture of a camera at the time of capturing image data. The sensor data can include, for example, inclination data outputted from a gyro sensor that measures the inclination of the camera capturing an image of the real space, acceleration data outputted from an acceleration sensor that measures the acceleration of the camera, and so forth. The sensor data is not limited to information associated with the camera; the sensor data can include, for example, data of a position measured by a GPS (Global Positioning System) as a position information measurement system.

### (1-1-4) Recognition Unit 30

The recognition unit 30 recognizes a plane or target object existing in a designated place in an image by using the three-dimensional model data acquired by the data acquisition unit 20. The recognition unit 30 recognizes the plane or target object existing in the designated place in the image by transforming two-dimensional positions in the image into three-dimensional positions in the real space according to a pinhole camera model and matching the three-dimensional positions with the three-dimensional model data. Incidentally, the two-dimensional position in the image is represented by pixel coordinates.

Further, the recognition unit 30 receives an image as an input and recognizes the position and the posture of the camera that captured the image based on the received image. As a method for estimating the position-posture pair of a camera that captured an image based on the image, there has been known a method using a neural network, called PoseNet, for example. This method is described in Non-patent Reference 2, for example.

Non-patent Reference 2: Charles R. Qi and three others, “PointNet: Deep Learning on Point Sets for 3D Classification and Segmentation”, Stanford University

As another method for estimating the position-posture pair of a camera that captured an image based on the image, there has been known a method using the SLAM technology.

### (1-1-5) Authoring Unit 10

The authoring unit 10 executes the authoring of the virtual object by using the three-dimensional model data acquired by the data acquisition unit 20, the virtual object data, or both of these sets of data. The authoring unit 10 outputs the result of the authoring as the authoring data. The authoring unit 10 executes the authoring so that the virtual object related to a place designated by the user, that is, a region at the designation target designated by the user, has a position in a depth direction coinciding with the position of the designation target region in the depth direction. As shown in FIG. 2, the authoring unit 10 includes a user interface unit 11 as a user interface, a designation target determination unit 12, an arrangement position calculation unit 13 and a multiple viewpoints calculation unit 14.

### (1-1-6) User Interface Unit 11

The user interface unit 11 provides a user interface for the authoring. The user interface unit 11 includes, for example, the input device 103 and the display device 104 shown in FIG. 1 and so forth. The user interface unit 11 can include a GUI (Graphical User Interface) application. Specifically, the user interface unit 11 makes the display device 104 display an image or three-dimensional data to be used for the authoring (e.g., three-dimensional point set data, plane data, etc.), and receives user operations necessary for the authoring from the input device 103. Here, the three-dimensional data can include, for example, three-dimensional point set data, plane data, etc.

The user's input operations performed by using the input device 103 will be described below. In an “operation U1”, the user designates an image to be used for the authoring. For example, in the “operation U1”, the user selects one image from the images shown in FIGS. 3A, 3B and 3C. In an “operation U2”, the user designates the designation target as the reference for the AR image. In an “operation U3”, the user performs an operation for arranging the virtual object. In an “operation U4”, the user designates the number of plane patterns. The number of plane patterns is the number of planes obtained by calculation by the multiple viewpoints calculation unit 14 which will be described later.

In the image designated in the “operation U1”, the user designates the designation target in the “operation U2”, based on which the designation target determination unit 12 and the arrangement position calculation unit 13 obtain the three-dimensional position of the designation target and an arrangement plane as a plane on which the virtual object related to the designation target is arranged.

On the obtained plane, the user designates the position of arranging the virtual object in the “operation U3”, based on which the arrangement position calculation unit 13 calculates the three-dimensional position and posture of the virtual object. Further, the user designates the number G (G: positive integer) of plane patterns in the “operation U4”, based on which the multiple viewpoints calculation unit 14 is capable of obtaining the arrangement positions of the virtual object in cases where the designation target is viewed from G viewpoints (in sight line directions of G patterns).

### (1-1-7) Designation Target Determination Unit 12

The designation target determination unit 12 determines a reference point p and a reference plane Sₚ based on the designation target designated by the user through the user interface unit 11. There are a first designation method and a second designation method as methods for designating the designation target. As the method for deriving the reference point p and the reference plane Sₚ, the designation target determination unit 12 uses a different method for each method of designating the designation target.

### (First Designation Method)

In the first designation method, on an image in which a GUI is displayed, the user performs an operation of surrounding a region to be set as the designation target by straight lines of a rectangle, a polygon or the like. The place surrounded by the straight lines becomes the region as the designation target. In a case where the designation target has been designated by the first designation method, the reference point p and the reference plane Sₚ are obtained as follows:

Apices of an n-sided polygon region designated as the designation target are defined as H₁, . . . , Hₙ. Here, n is an integer larger than or equal to 3. The apices H₁, . . . , Hₙ are represented by pixel coordinates (u, v) in the GUI image. These coordinates are transformed into three-dimensional coordinates aᵢ=(x, y, z) according to the pinhole camera model. Here, i=1, 2, . . . , n.

Let b₁, b₂ and b₃ represent three points arbitrarily selected from the three-dimensional coordinates a₁, . . . , aₙ, a plane Sm containing the points b₁, b₂ and b₃ is obtained uniquely. Further, among the apices H₁, . . . , Hₙ of the n-sided polygon region, a set C of points not selected as the three points b₁, b₂ and b₃ is represented as follows:

C={c₁, c₂, . . . , cₙ₋₃}

There are J ways indicated by the following expression (1) as the methods of selecting three points from the three-dimensional coordinates a₁, . . . , aₙ. Here, J is a positive integer.

J=ₙC₃ (1)

Thus, there exist J planes that are obtained from arbitrary three points selected from the apices of the n-sided polygon. The J planes are represented as Sm₁, . . . , Sm_{J}.

Further, as sets C₁, . . . , C_{J} of points obtained by excluding arbitrary three points from the apices H₁, . . . , Hₙ of the n-sided polygon region, there exist J sets as shown below.

$${C}_{1} = \{ {c}_{1 , 1} , {c}_{1 , 2} , … , {c}_{1 , n - 3} \} , … , {C}_{J} = \{ {c}_{J , 1} , {c}_{J , 2} , … , {c}_{J , n - 3} \}$$

Incidentally, the element C_{1,n-3} represents the (n-3)-th element, that is, the (n-3)-th point, in the set C₁, for example.

Let D(S, X) represent the distance between a plane S and a point X, the reference plane Sₚ is obtained by the following expression (2). Among a plurality of planes obtained from three points selected from the apices of the n-sided polygon, a plane whose average of distances to other points is the smallest is defined as the reference plane Sₚ. Here, the “other points” mean points not constituting the plane.

$${S}_{p} = arg {min}_{S {m}_{i}} \frac{1}{J} {\sum }_{j = 1}^{J} D ( S {m}_{i} , {C}_{i , j} ) \qquad ( 2 )$$

Here, the element C_{i,j} is the j-th element in the set Cᵢ.

Further, let A_{G} represent the coordinates of the barycenter of the n-sided polygon, an intersection point of a perpendicular line drawn from the coordinates A_{G} to the reference plane Sₚ obtained by the expression (2) and the reference plane Sₚ is defined as the reference point p.

### (Second Designation Method)

On an image in which a GUI is displayed, the user perfoms an operation of designating one point to be set as the designation target. In the second designation method, in a case where the point as the designation target region has been designated by the user, the reference point p and the reference plane Sₚ are obtained as follows:

Assuming that the point in the image where the reference point p was designated is M=(u, v), M can be transformed into three-dimensional coordinates aᵢ=(x, y, z) according to the pinhole camera model. In the second designation method, the three-dimensional coordinates aᵢ are directly used as the coordinates of the reference point p.

The recognition unit 30 determines the reference plane Sₚ by detecting a plane containing the reference point p in the plane data in the three-dimensional model data. When no corresponding plane exists, the recognition unit 30 may detect a quasi plane by using point set data around the reference point p and by making use of RANSAC (RANdom Sample Consensus), for example.

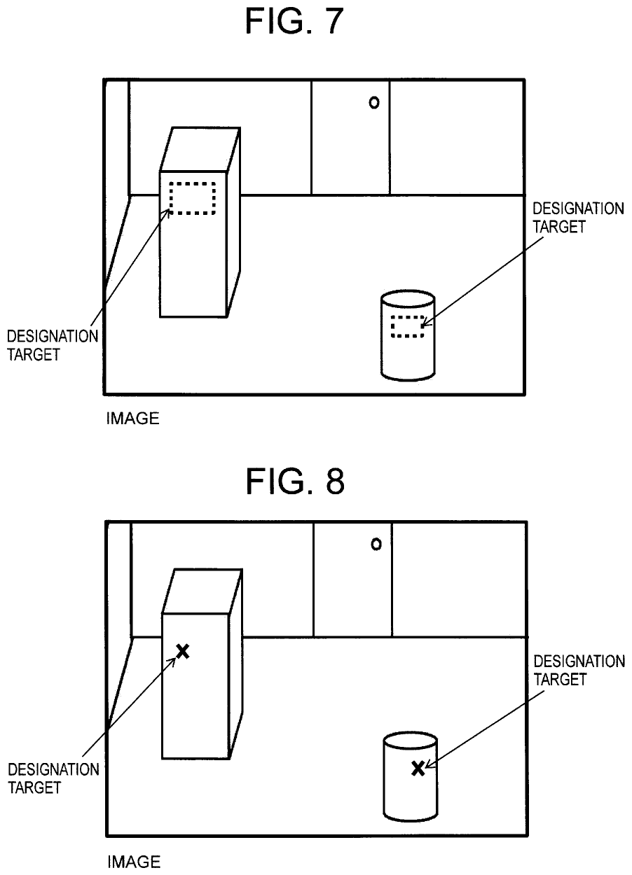

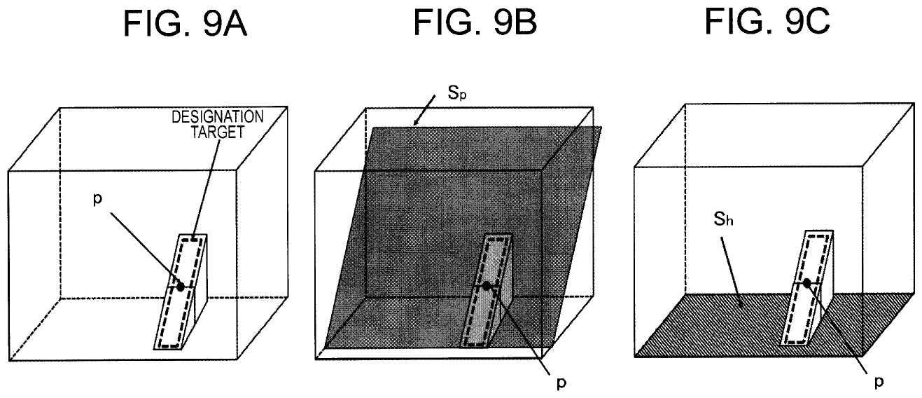

FIG. 7 is a diagram showing the first designation method of designating the designation target by a user operation of surrounding a region on the target object as the designation target by straight lines. FIG. 8 is a diagram showing the second designation method of designating the designation target by a user operation of designating a point on the target object as the designation target. In the second designation method shown in FIG. 8, a plane is detected based on only one point, and thus there are cases where the reference plane Sₚ cannot be detected appropriately when the target object as the designation target is not a plane. However, by using the first designation method shown in FIG. 7, the reference plane Sₚ can be derived even when the shape of the target object as the designation target is not planar.

### (1-1-8) Arrangement Position Calculation Unit 13

The arrangement position calculation unit 13 executes a first process 13a and a second process 13b described below.

In the first process 13a, the arrangement position calculation unit 13 calculates an arrangement plane S_{q} on which the virtual object is arranged. The arrangement position calculation unit 13 derives the arrangement plane S_{q}, as a plane on which the virtual object is arranged, from the reference point p and the reference plane Sₚ obtained by the designation target determination unit 12. As the method of deriving the arrangement plane S_{q}, there are a first deriving method and a second deriving method.

### (First Deriving Method)

In the first deriving method, the arrangement position calculation unit 13 handles the reference plane Sₚ directly as the arrangement plane S_{q}.

### (Second Deriving Method)

In the second deriving method, the arrangement position calculation unit 13 first detects a horizontal plane Sₕ in the real space based on the three-dimensional model data. The horizontal plane Sₕ may also be selected by a user operation performed by the user by using the user interface unit 11. Further, the horizontal plane Sₕ may also be automatically determined by using image recognition and space recognition technology. FIG. 9A is a diagram showing an example of the designation target region and the reference point p designated by the user operation. FIG. 9B is a diagram showing an example of the reference point p and the reference plane Sₚ. FIG. 9C is a diagram showing an example of the horizontal plane Sₕ.

FIGS. 10A, 10B and 10C are diagrams showing a process of deriving the arrangement plane S_{q} from the reference plane Sₚ and the horizontal plane Sₕ. In this case, in the second deriving method, the arrangement position calculation unit 13 derives the arrangement plane S_{q} by the process shown in FIGS. 10A, 10B and 10C.

First, as shown in FIG. 10A, the intersection line of the reference plane Sₚ and the horizontal plane Sₕ is defined as L. Subsequently, as shown in FIG. 10B, the reference plane Sₚ is rotated around the intersection line L as a central axis to form a plane Sᵥ vertical to the horizontal plane Sₕ. Subsequently, as shown in FIG. 10C, the plane Sᵥ vertical to the horizontal plane Sₕ is translated so as to include the reference point p. Subsequently, the plane Sᵥ vertical to the horizontal plane Sₕ and including the reference point p is defined as the arrangement plane S_{q}.

In the first deriving method, the arrangement plane with low visibility can be obtained depending on the inclination of the designation target region. However, by obtaining the plane Sᵥ vertical to the horizontal plane Sₕ and including the reference point p as the arrangement plane S_{q} as in the second deriving method, the position of the virtual object in the depth direction can be aligned with the reference point p as a reference position of the designation target region in the depth direction irrespective of the inclination of the designation target region.

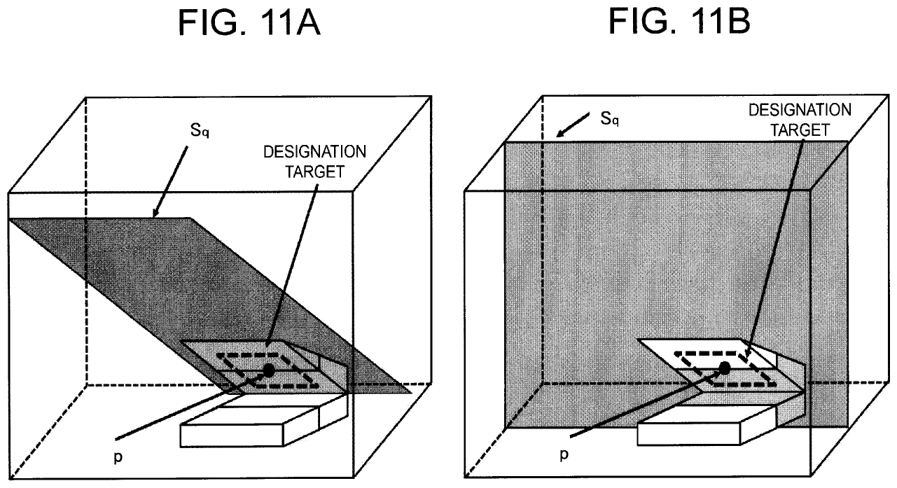

FIGS. 11A and 11B are diagrams showing the first deriving method and the second deriving method for deriving the arrangement plane S_{q}, on which the virtual object is arranged, from the reference point p and the reference plane Sₚ.

In the second process 13b, the arrangement position calculation unit 13 calculates a three-dimensional arrangement position q of the virtual object. After the arrangement plane S_{q} on which the virtual object is arranged is derived by the first process 13a by the arrangement position calculation unit 13, the user designates the arrangement position of the virtual object by using a GUI. For example, the user designates the arrangement position of the virtual object by clicking on a place in an image where the user wants to arrange the virtual object by using the input device 103 such as a mouse. At this point, it is also possible to assist the user's arrangement position designation operation by projecting the arrangement plane S_{q} onto the GUI image.

Let D=(u, v) represent the coordinates in the image obtained by the designation by the user, three-dimensional coordinates E=(x, y, z) can be obtained from the coordinates D according to the pinhole camera model. Let F=(x_{c}, y_{c}, z_{c}) represent the three-dimensional coordinates of the camera obtained from the three-dimensional model data, an intersection point of the arrangement plane S_{q} and a vector formed by two points at the coordinates E and the coordinates F is defined as the arrangement position q. Further, it is also possible to arrange a plurality of virtual objects in regard to one designation target. When t (t: positive integer) virtual objects are arranged, arrangement positions q₁, q₂, . . . , qₜ are derived by the same procedure.

Further, after determining the arrangement position, the size of the virtual object may be changed by the user by a user operation such as a drag-and-drop operation. In this case, at the time of the user operation, it is desirable to display the virtual object, obtained as the result of the rendering, on the display device 104.

Furthermore, at that time, the user may change the direction (i.e., posture) in which the virtual object is arranged by performing a user operation such as a drag-and-drop operation. In this case, information regarding the rotation of the virtual object is also stored in the storage 105 as the authoring data. By executing the process described above, the three-dimensional arrangement position, the range and the posture of the virtual object are obtained.

### (1-1-9) Multiple Viewpoints Calculation Unit 14

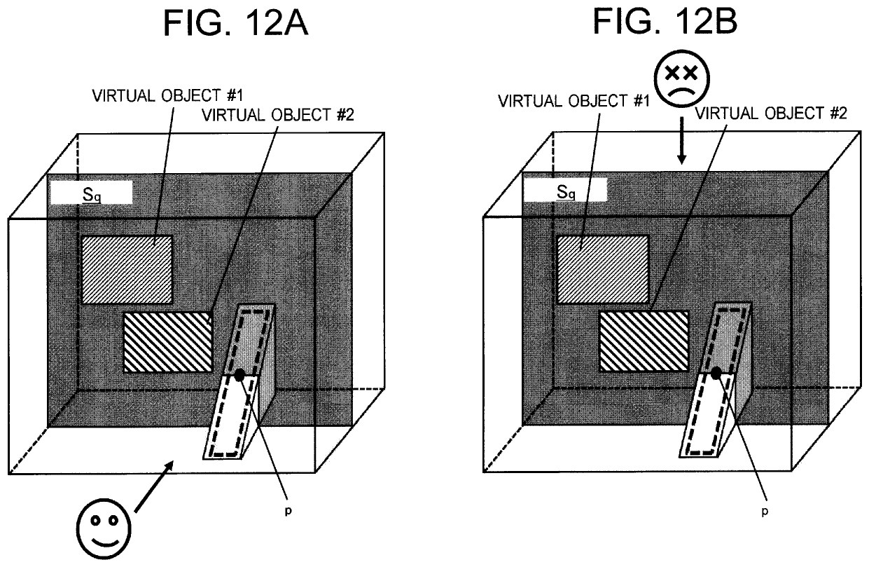

As the result of the processing by the components to the arrangement position calculation unit 13, the position of the designation target region in the depth direction and the position of the virtual object in the depth direction have been aligned with each other as viewed from a certain one direction. FIG. 12A is a diagram indicating that virtual objects #1 and #2 displayed on the arrangement plane S_{q} can be seen when the designation target region is viewed from the front. FIG. 12B is a diagram indicating that the virtual objects #1 and #2 displayed on the arrangement plane S_{q} cannot be seen when the designation target region is viewed from above.

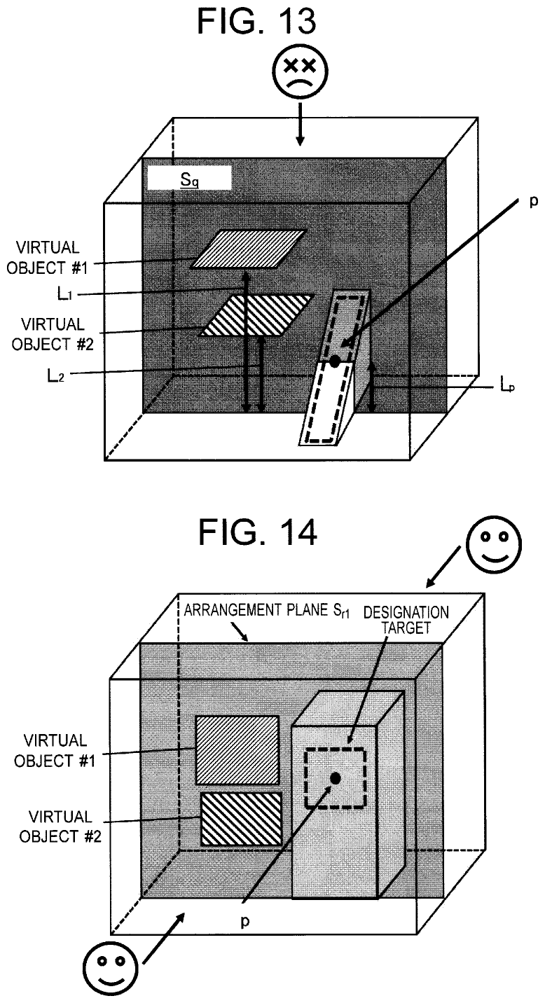

FIG. 13 is a diagram showing an example of displaying the virtual objects #1 and #2 by using billboard rendering. When the rendering has been executed by using the billboard rendering so that each virtual object is constantly in a posture orthogonal to a sight line vector of the camera, the virtual object can be seen as shown in FIG. 13. However, positions L₁ and L₂ of the virtual objects #1 and #2 in the depth direction are deviated from a position Lₚ of the designation target region in the depth direction.

In order to make the position of each virtual object in the depth direction coincide with the position of the designation target region in the depth direction even when the viewpoint changes greatly as above, the multiple viewpoints calculation unit 14 prepares a plurality of arrangement planes for one designation target, and executes the calculation of the arrangement position of the virtual object in regard to each arrangement plane. The multiple viewpoints calculation unit 14 repeats a first viewpoint calculation process 14a and a second viewpoint calculation process 14b described below for a number of times equal to the number of added arrangement planes.

In the first viewpoint calculation process 14a, the multiple viewpoints calculation unit 14 determines a plane Sᵣ obtained by rotating the arrangement plane S_{q} obtained by the arrangement position calculation unit 13 around an axis passing through the reference point p.

In the second viewpoint calculation process 14b, the multiple viewpoints calculation unit 14 obtains arrangement positions qᵣ₁, qᵣ₂, . . . , qᵣₜ of arranged virtual objects v₁, v₂, . . . , vₜ obtained by the arrangement position calculation unit 13 on the plane Sᵣ.

In regard to the first viewpoint calculation process 14a, it is also possible to let the user himself/herself set the plane Sᵣ by a user operation such as the drag-and-drop operation. Further, the multiple viewpoints calculation unit 14 may have a function of automatically obtaining the plane Sᵣ. Examples of the method of automatically obtaining the plane Sᵣ will be described later.

In regard to the second viewpoint calculation process 14b, the multiple viewpoints calculation unit 14 is capable of obtaining the arrangement positions qᵣ₁, qᵣ₂, . . . , qᵣₜ on the plane Sᵣ by using relative positional relationship on the arrangement plane S_{q} between the reference point p and the arrangement positions q₁, q₂, . . . , qₜ of the virtual objects v₁, v₂, . . . , vₜ obtained by the arrangement position calculation unit 13.

Further, after obtaining temporary arrangement positions by the above-described method, it is also possible to provide the user with a user interface to let the user adjust the arrangement positions. Furthermore, after obtaining the temporary arrangement positions, the multiple viewpoints calculation unit 14 may adjust the arrangement positions of the virtual objects by making a judgment on collision of the virtual objects and the target objects in the real space by using the point set data in the partial three-dimensional model data, the plane data in the partial three-dimensional model data, or both of these sets of data.

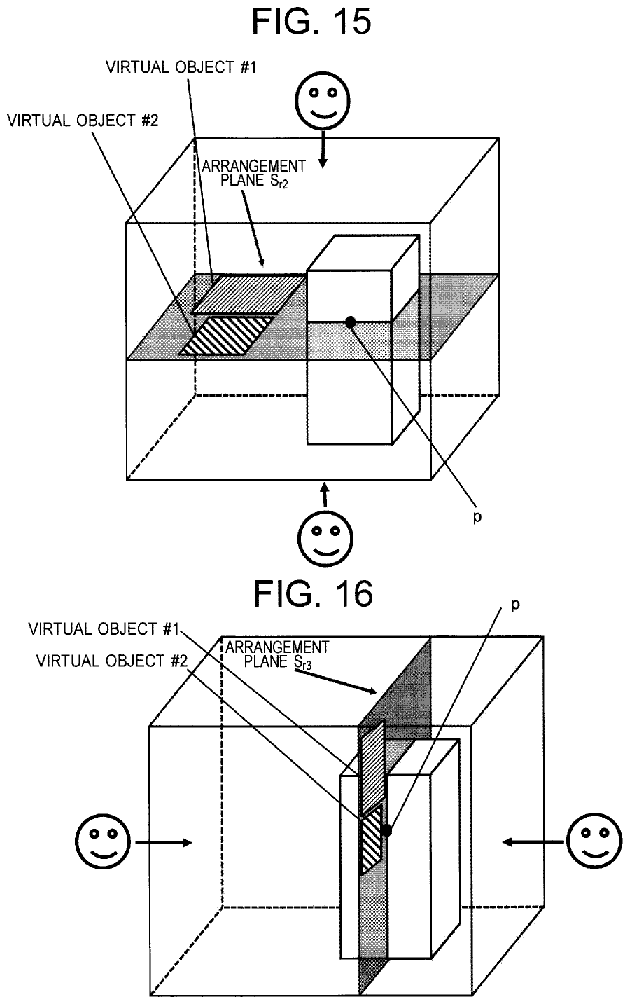

Examples of the method of automatically obtaining the plane Sᵣ in the first viewpoint calculation process 14a will be described below. An example in which the number of the planes Sᵣ is three will be described here. When the number of the planes is three, the multiple viewpoints calculation unit 14 derives arrangement planes Sᵣ₁, Sᵣ₂ and Sᵣ₃ as the planes Sᵣ. FIG. 14 is a diagram showing the arrangement plane Sᵣ₁ derived by the multiple viewpoints calculation unit 14. FIG. 15 is a diagram showing an example of the arrangement plane Sᵣ₂ derived by the multiple viewpoints calculation unit 14. FIG. 16 is a diagram showing an example of the arrangement plane Sᵣ₃ derived by the multiple viewpoints calculation unit 14. The examples of FIG. 14 to FIG. 16 show the arrangement planes Sᵣ₁, Sᵣ₂ and Sᵣ₃ taking into account that the designation target is viewed from front and back, above and below, and left and right. In the cases of the examples, the arrangement planes Sᵣ₁, Sᵣ₂ and Sᵣ₃ can be obtained as below with no user operation.

The example shown in FIG. 14 is an example in which the arrangement plane S_{q} derived by the arrangement position calculation unit 13 is directly handled as the arrangement plane Sᵣ₁.

The arrangement plane Sᵣ₂ shown in FIG. 15 is a plane obtained by rotating the arrangement plane S_{q} around a horizontal axis passing through the reference point p to be in parallel with the horizontal plane Sₕ detected by the arrangement position calculation unit 13.

The arrangement plane Sᵣ₃ shown in FIG. 16 is a plane obtained by changing the arrangement plane S_{q} to be in a direction orthogonal to both of the arrangement plane Sᵣ₁ and the arrangement plane Sᵣ₂, and including the reference point p.

As above, the arrangement position calculation unit 13 calculates a plurality of arrangement planes and arrangement positions and outputs the result of the calculation as the authoring data. At the time of executing the rendering, by switching the plane as the target of the rendering depending on the angle of the camera, the depth direction positions of a plurality of virtual objects related to the designation target can be made to coincide with the position of the designation target in the depth direction even when the virtual objects are viewed from a plurality of viewpoints.

### (1-1-10) Authoring Data

The authoring data is data stored in the storage 105 indicating the result of the authoring executed by the authoring unit 10. The authoring data includes the following first to sixth information I1 to I6, for example:

The first information I1 is information regarding the designation target and includes information on the reference point p and the reference plane Sₚ. The second information 12 is information regarding the arrangement plane and includes information on the arrangement plane S_{q} and the plane Sᵣ. The third information I3 is information regarding the virtual objects and includes information on the virtual objects v₁, v₂, . . . . The fourth information I4 is information indicating the arrangement positions of the virtual objects. The fifth information I5 is information indicating the arrangement ranges of the virtual objects. The sixth information I6 is information indicating the postures of the virtual objects. The information indicating the postures is referred to also as information indicating the directions of the virtual objects.

The three-dimensional arrangement positions of the virtual objects obtained by the authoring unit 10 are managed while being associated with the arrangement plane, the designation target, or both of these items of information.

### (1-2) Operation

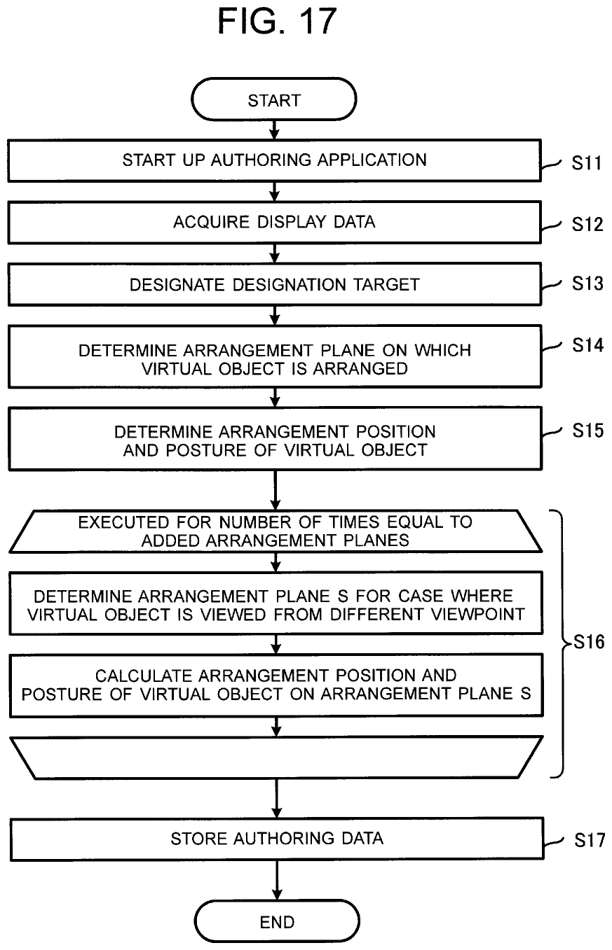

FIG. 17 is a flowchart showing the operation of the authoring device 1 according to the first embodiment. First, in step S11, according to user instructions, the authoring device 1 starts up an authoring application having the functions of the authoring unit 10.

In step S12, the authoring device 1 acquires an image, a three-dimensional point set as three-dimensional data, or a plane, to be used for the authoring, designated by the user through the user interface unit 11 of the authoring unit 10, and displays the acquired image or three-dimensional data on the display device 104. The designation by the user is performed by using a mouse, a touch pad or the like as the user interface unit 11.

In step S13, the authoring device 1 determines the designation target of the image or three-dimensional data designated by the user through the user interface unit 11. The authoring device 1 obtains the reference point p and the reference plane Sₚ based on the designation target designated by the user.

In step S14, the authoring device 1 determines the arrangement plane S_{q} on which the virtual object is arranged.

In step S15, the authoring device 1 receives information regarding the arrangement position, size, rotation, etc. of the virtual object inputted by user operations. Based on the received information, the authoring device 1 calculates information such as the three-dimensional arrangement position and the posture of the virtual object.

In step S16, to deal with rendering from a plurality of viewpoints, the authoring device 1 obtains the arrangement plane, the arrangement position of the virtual object placed on the arrangement plane, and so forth for the number of times equal to the number of added planes. At that time, there are a case where the added arrangement plane is designated on a GUI by a user operation and a case where the added arrangement plane is determined automatically with no user operation.

In step S17, after obtaining the authoring information regarding the virtual object on a plurality of planes, the authoring device 1 outputs the information on the authoring obtained by the processing so far as authoring data and stores the authoring data in the storage 105.

### (1-3) Effect

As described above, in the first embodiment, when the authoring is executed based on the target object as the designation target in the real space and a virtual object related to the target object as the designation target, the reference point p and the reference plane Sₚ are obtained from the user's designation target by the designation target determination unit 12. Accordingly, the position of the virtual object in the depth direction can be made to coincide with the position of the designation target in the depth direction irrespective of the shape and the inclination of the designation target.

Further, a plurality of virtual object arrangement planes are obtained by the multiple viewpoints calculation unit 14. Accordingly, even when the direction or posture of the camera is changed, the position of the virtual object in the depth direction can be made to coincide with the position of the designation target in the depth direction.

Furthermore, even in cases where a plurality of contents have been registered in regard to one designation target, the positions of the virtual objects in the depth direction can be made to coincide with the position of the designation target in the depth direction even when the direction or posture of the camera is changed.

### (2) Second Embodiment

### (2-1) Configuration

### (2-1-1) Hardware Configuration

While the authoring device 1 according to the first embodiment is a device that generates and outputs authoring data, the authoring device may also include a configuration for executing rendering.

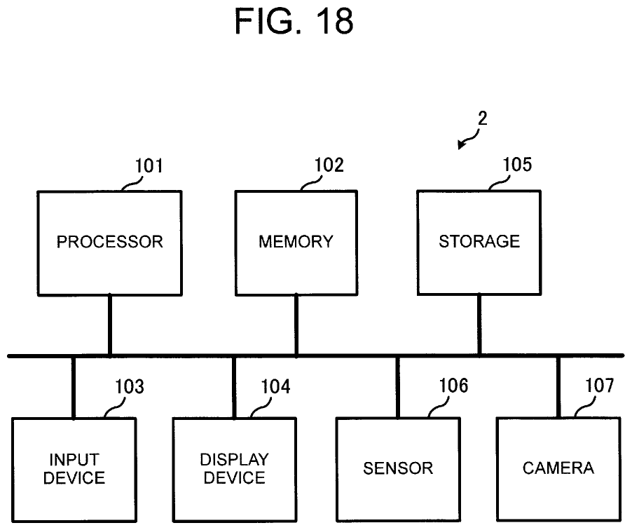

FIG. 18 is a diagram showing an example of a hardware configuration of an authoring device 2 according to a second embodiment of the present invention. In FIG. 18, each component identical or corresponding to a component shown in FIG. 1 is assigned the same reference character as in FIG. 1. The authoring device 2 according to the second embodiment differs from the authoring device 1 according to the first embodiment in including a sensor 106 and a camera 107.

The sensor 106 is an IMU (Inertial Measurement Unit), an infrared ray sensor, a LiDAR (Light Detection and Ranging), or the like. The IMU is a detection device in which various types of sensors such as an acceleration sensor, a geomagnetism sensor and a gyro sensor have been integrated together. The camera 107 is an image capturing device such as a monocular camera, a stereo camera or an RGBD camera, for example.

The authoring device 2 estimates the position and the posture of the camera 107 from image data outputted from the camera 107 capturing an image of the real space, selects a display plane on which the virtual object is arranged from a first arrangement plane and one or more second arrangement planes based on the estimated position and posture of the camera 107 and the authoring data, and outputs display image data based on the image data and the virtual object arranged on the display plane.

From the first arrangement plane and one or more second arrangement planes, the authoring device 2 selects an arrangement plane, with which an angle made by the first arrangement plane and a vector determined by the position of the camera 107 and the reference point p or an angle made by the second arrangement plane and the vector is closest to 90 degrees, as the display plane on which the virtual object is displayed.

### (2-1-2) Authoring Device 2

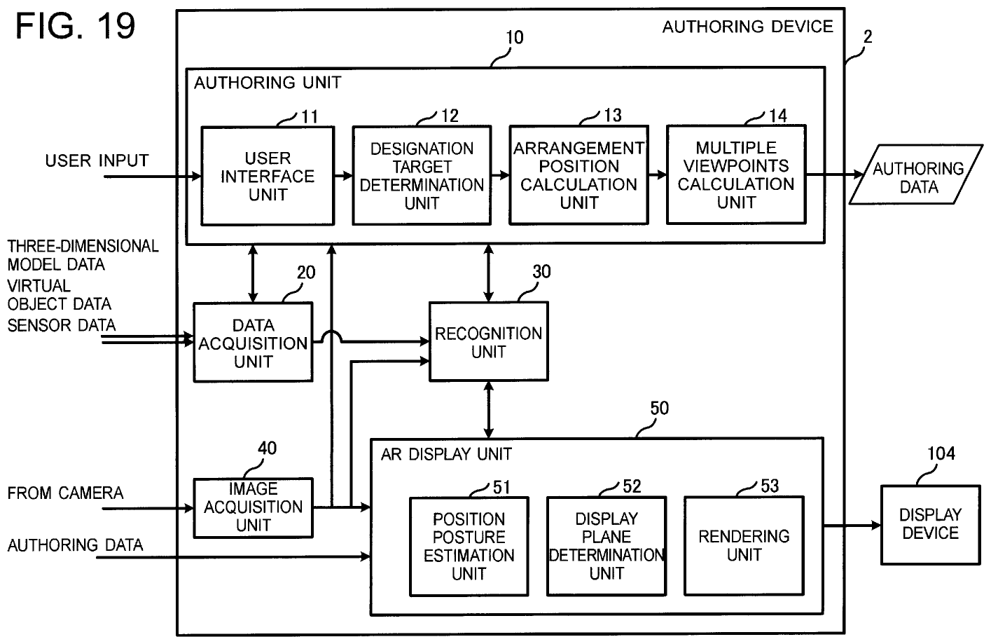

FIG. 19 is a functional block diagram schematically showing a configuration of the authoring device 2 according to the second embodiment. In FIG. 19, each component identical or corresponding to a component shown in FIG. 2 is assigned the same reference character as in FIG. 2. The authoring device 2 according to the second embodiment differs from the authoring device 1 according to the first embodiment in including an image acquisition unit 40 and an AR display unit 50 that outputs image data to the display device 104.

The image acquisition unit 40 acquires image data outputted from the camera 107. The image data acquired by the image acquisition unit 40 is inputted to the authoring unit 10, the recognition unit 30 and the AR display unit 50. In a case where the authoring is executed by using the image data outputted from the camera 107, the image data outputted from the camera 107 is inputted to the authoring unit 10. In other cases, the image data outputted from the camera 107 is inputted to the AR display unit 50.

### (2-1-3) AR Display Unit 50

The AR display unit 50 executes the rendering, for generating image data for displaying the virtual object on the display device 104, by using the authoring data outputted from the authoring unit 10 or stored in the storage 105. As shown in FIG. 19, the AR display unit 50 includes a position posture estimation unit 51, a display plane determination unit 52 and a rendering unit 53.

### (Position Posture Estimation Unit 51)

The position posture estimation unit 51 estimates the position and the posture of the camera 107 connected to the authoring device 2. Image data of a captured image acquired from the camera 107 by the image acquisition unit 40 is provided to the recognition unit 30. The recognition unit 30 receives the image data as the input and recognizes the position and the posture of the camera that captured the image based on the received image data. Based on the result of the recognition by the recognition unit 30, the position posture estimation unit 51 estimates the position and the posture of the camera 107 connected to the authoring device 2.

### (Display Plane Determination Unit 52)

In the authoring data in the second embodiment, there is a case where a plurality of arrangement planes exist for one designation target designated by the user due to the multiple viewpoints calculation unit 14. The plurality of arrangement planes are, for example, the arrangement planes Sᵣ₁, Sᵣ₂ and Sᵣ₃ shown in FIG. 14 to FIG. 16. The display plane determination unit 52 determines a plane as the target of the rendering from the plurality of arrangement planes by using the present position and posture information on the camera 107. A reference point corresponding to a certain designation target is represented as p, and t (t: positive integer) display planes are represented as S₁, S₂, . . . , Sₜ. Further, let θ₁, θ₂, . . . , θₜ respectively represent angles [°] made by a vector determined by the three-dimensional position of the camera 107 and the reference point p and the display planes S₁, S₂, . . . , Sₜ and let i represent an integer larger than or equal to 1 and smaller than or equal to t, the plane S_{R} as the target of the rendering is obtained as indicated by the following expression (3), for example, when 0°<θᵢ≤90°. The vector determined by the three-dimensional position of the camera 107 and the reference point p is, for example, a vector in a direction connecting the position of the optical axis of the camera 107 and the reference point p.

$${S}_{R} = arg {min}_{{S}_{i}} ( 90 - {θ}_{i} ) \qquad ( 3 )$$

However, when 90°<θᵢ≤180°, the plane S_{R} as the target of the rendering is obtained as indicated by the following expression (4), for example.

$${S}_{R} = arg {min}_{{S}_{i}} ( {θ}_{i} - 90 ) \qquad ( 4 )$$

After obtaining the plane S_{R}, data such as the arrangement position of the virtual object included in the plane S_{R} are acquired from the authoring data and outputted to the rendering unit 53. Namely, a display plane with which the angle made by the display plane and the vector determined by the three-dimensional position of the camera 107 and the reference point p is closest to 90 degrees is selected as the plane S_{R}.

### (Rendering Unit 53)

Based on information on the position and the posture of the camera 107 obtained by the position posture estimation unit 51 and the arrangement plane and the arrangement position of the virtual object obtained by the display plane determination unit 52, the rendering unit 53 transforms the three-dimensional coordinates of the virtual object into two-dimensional coordinates on the display of the display device 104 and displays the virtual object on the display of the display device 104 in superimposition on the two-dimensional coordinates obtained by the transformation.

### (2-1-4) Display Device 104

The display device 104 is a device for rendering the AR image. The display device 104 is, for example, a display of a PC (Personal Computer), a display of a smartphone, a display of a tablet terminal, a head-mounted display, or the like.

### (2-2) Operation

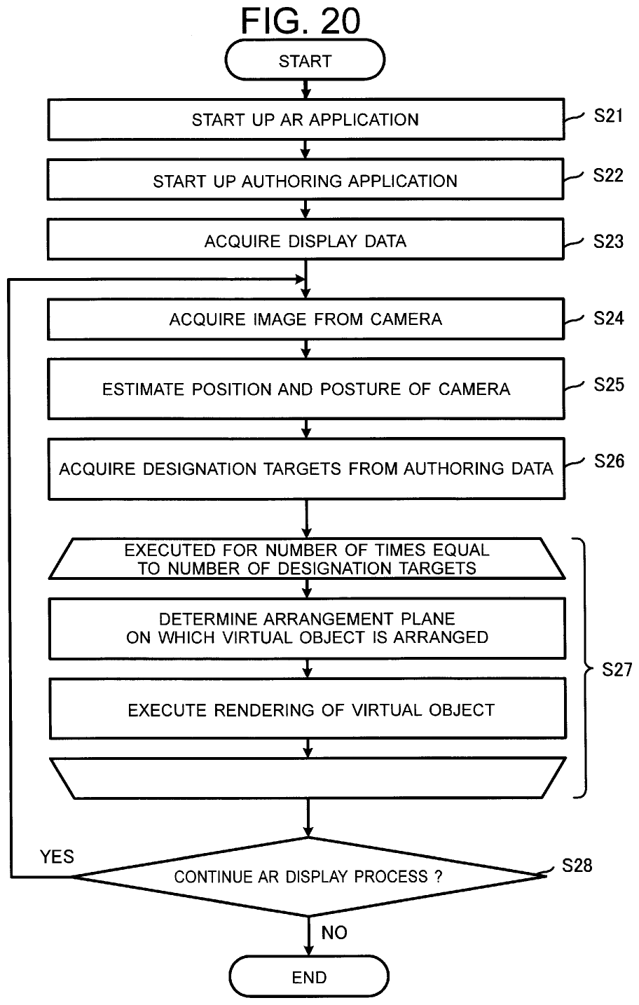

FIG. 20 is a flowchart showing an operation of the authoring device 2 according to the second embodiment. The authoring executed by the authoring device 2 according to the second embodiment is the same as that in the first embodiment.

In step S21, the authoring device 2 starts up an AR application.

After authoring application is started up in step S22, the authoring device 2 in step S23 acquires the authoring data as display data.

In step S24, the authoring device 2 acquires the image data of the captured image outputted from the camera 107 connected to the authoring device 2.

In step S25, the authoring device 2 estimates the position and the posture of the camera 107.

In step S26, the authoring device 2 acquires information regarding the determined designation target(s) from the authoring data, and executes processing of step S27 for one designation target or each of a plurality of designation targets.

In the step S27, the authoring device 2 determines one arrangement plane, on which the virtual object is displayed, from a plurality of arrangement planes corresponding to the designation target. Subsequently, the authoring device 2 acquires information regarding the arrangement position, the size, the position, the posture, etc. of the virtual object arranged on the determined arrangement plane from the authoring data. Subsequently, the authoring device 2 executes the rendering of the virtual object.

In step S28, the authoring device 2 makes a judgment on whether the AR display process should be continued or the process has been finished for all of the registered designation targets. When the AR display process should be continued, the processing from the step S24 to the step S27 is repeated.

### (2-3) Effect

As described above, in the second embodiment, when the designation target as the target of the virtual object and the virtual object related to the designation target are rendered, the rendering based on the authoring data outputted by the authoring unit 10 is executed. Accordingly, it becomes possible to execute rendering that makes the position of the virtual object in the depth direction coincide with the position of the designation target in the depth direction irrespective of the shape or the inclination of the designation target.

Further, from a plurality of content arrangement planes obtained by the multiple viewpoints calculation unit 14, the plane as the target to the rendering is determined by the display plane determination unit 52 based on the position of the camera 107, the posture of the camera 107, or both of these items of information. Accordingly, the position of the virtual object in the depth direction can be made to coincide with the position of the designation target in the depth direction even when there is a change in the position of the camera 107, the posture of the camera 107, or both of these items of information.

### DESCRIPTION OF REFERENCE CHARACTERS

1, 2: authoring device, 10: authoring unit, 11: user interface unit, 12: designation target determination unit, 13: arrangement position calculation unit, 14: multiple viewpoints calculation unit, 20: data acquisition unit, 30: recognition unit, 40: image acquisition unit, 50: AR display unit, 51: position posture estimation unit, 52: display plane determination unit, 53: rendering unit, 101: processor, 102: memory, 103: input device, 104: display device, 105: storage, 106: sensor, 107: camera, p: reference point, Sₚ: reference plane, Sₕ: horizontal plane, S_{q}: arrangement plane, Sᵣ₁, Sᵣ₂, Sᵣ₃: arrangement plane.

What is claimed is:

1. An authoring device comprising:
a user interface to receive an operation for designating a target object existing in real space; and
processing circuitry
to determine a reference point of a designation target, as the target object designated by using the user interface, on a reference plane related to the target object;
to determine a first arrangement plane, arranged at a position including the reference point and on which a virtual object can be arranged, based on the reference plane and the reference point; and
to determine one or more second arrangement planes obtained by rotating the first arrangement plane and on which the virtual object can be arranged,
wherein the authoring device outputs information associating the first arrangement plane and the virtual object with each other and information associating the second arrangement planes and the virtual object with each other as authoring data.

2. The authoring device according to claim 1, wherein the operation by using the user interface is an operation of surrounding a region representing the target object as the designation target by an n-sided polygon where n is an integer larger than or equal to three.

3. The authoring device according to claim 2, wherein the processing circuitry
determines one of planes including three apices among apices of the n-sided polygon as the reference plane, and
determines the reference point based on a barycenter position of the n-sided polygon and the reference plane.

4. The authoring device according to claim 1, wherein the processing circuitry determines the one or more second arrangement planes by rotating the first arrangement plane around an axis line including the reference point.

5. The authoring device according to claim 1, wherein the processing circuitry
estimates a position and a posture of a camera that captures an image of real space based on image data outputted from the camera;
selects a display plane on which the virtual object is arranged from the first arrangement plane and the one or more second arrangement planes based on the estimated position and posture of the camera and the authoring data; and
outputs display image data based on the image data and the virtual object arranged on the display plane.

6. The authoring device according to claim 5, wherein from the first arrangement plane and the one or more second arrangement planes, the processing circuitry selects an arrangement plane, with which an angle made by the first arrangement plane and a vector determined by the position of the camera and the reference point or an angle made by the second arrangement plane and the vector is closest to 90 degrees, as the display plane on which the virtual object is displayed.

7. An authoring method comprising:
receiving an operation for designating a target object existing in real space;
determining a reference point of a designation target as the designated target object on a reference plane related to the target object;
determining a first arrangement plane, arranged at a position including the reference point and on which a virtual object can be arranged, based on the reference plane and the reference point;
determining one or more second arrangement planes obtained by rotating the first arrangement plane and on which the virtual object can be arranged; and
outputting information associating the first arrangement plane and the virtual object with each other and information associating the second arrangement planes and the virtual object with each other as authoring data.

8. A non-transitory computer-readable storage medium for storing an authoring program that causes a computer to execute processing comprising:
receiving an operation for designating a target object existing in real space;
determining a reference point of a designation target as the designated target object on a reference plane related to the target object;
determining a first arrangement plane, arranged at a position including the reference point and on which a virtual object can be arranged, based on the reference plane and the reference point;
determining one or more second arrangement planes obtained by rotating the first arrangement plane and on which the virtual object can be arranged; and
outputting information associating the first arrangement plane and the virtual object with each other and information associating the second arrangement planes and the virtual object with each other as authoring data.
